(19) United States
(12) Patent Application Publication
(10) Pub. No.: US 2012/0242637 A1
(43) Pub. Date: Sep. 27, 2012

(54) Liquid Crystal Display Apparatus

(75) Inventor: Hiroshi Yamashita, Daito-shi (JP)

(73) Assignee: Funai Electric Co., Ltd.

(21) Appl. No.: 13/424,485

(22) Filed: Mar. 20, 2012

(30) Foreign Application Priority Data
Mar. 24, 2011 (JP) 2011-066262

(51) Int. Cl. G09G 3/36; G09G 5/00

(52) U.S. Cl. 345/208; 345/88

(57) ABSTRACT

A liquid crystal display apparatus comprises a liquid crystal panel in which plural sub-pixels of red, green, blue, and a fourth color, which has a higher brightness than the other three colors, are arranged in a column direction and a row direction, and a signal control unit which generates drive signals for the respective sub-pixels. The signal control unit generates the drive signals for the respective sub-pixels not only so that each pixel of the liquid crystal panel is made up of four sub-pixels which are adjacent to one another in two consecutive columns and two consecutive rows, but also so that there is one column and one row overlap between every four pixels which are adjacent to one another in two consecutive columns and two consecutive rows.

### BACKGROUND OF THE INVENTION

1. Field of the Invention

The present invention relates to a liquid crystal display apparatus.

2. Description of the Related Art

A liquid crystal display apparatus includes a liquid crystal panel in which a number of sub-pixels are arranged in rows and columns and a signal control unit which generates drive signals inputted to each sub-pixel, and each sub-pixel emits red light, green light, blue light, or the like in accordance with the drive signals, so that a color is reproduced in each pixel and an image is displayed in color.

As shown in FIG. 6, conventionally, a liquid crystal panel 101 is made up of striped sub-pixels of red (R)-green (G)-blue (B) colors sequentially arranged in rows and columns. When the drive signals are inputted by wirings 104 and 105 which extend from a source driver 102 and a gate driver 103 in a matrix form, each sub-pixel is driven, and a color is reproduced in pixels P (1, 1), P (1, 2), . . . , and P (3, 3), respectively, by combining the three sub-pixels of red (R)-green (G)-blue (B) colors.

Moreover, as shown in FIG. 7, there is also a liquid crystal panel 201 which is made up of sub-pixels of red (R)-green (G)-blue (B)-white (W) colors in rows and columns to reproduce a color in each pixel by four sub-pixels of red (R)-green (G)-blue (B)-white (W) colors arranged in two rows and two columns (refer to Japanese Laid-Open Patent Publication No. 2008-64771 and Japanese Patent No. 4579874, for example). In the liquid crystal panel 201, colors in pixels P (1, 1), P (1, 2), . . . , and P (3, 3) are sequentially reproduced in each group of the adjacent four sub-pixels. The drive signals are inputted by wirings 204 and 205, which extend from a source driver 202 and a gate driver 203 in a matrix form, to each sub-pixel in the same manner as the configuration in FIG. 6.

Since the liquid crystal panel 201 has the white (W) sub-pixel of high brightness, a transmissivity in the whole liquid crystal panel (a transmissivity of light from a backlight) can be increased.

### BRIEF SUMMARY OF THE INVENTION

As described above, the liquid crystal panel 201 provided with the white sub-pixel shown in FIG. 7 has the higher transmissivity than the liquid crystal panel 101 which reproduces the color in the red, green, and blue sub-pixels shown in FIG. 6. However, the liquid crystal panel 201 has the disadvantage that a total number of the wirings to transmit the drive signals is more likely to increase in accordance with an increase of a total number of the sub-pixels, compared to the liquid crystal panel 101, and at least a total number of the wirings extending from the gate driver is twice as many as that of the liquid crystal panel 101.

The wirings interfere with the transmission of light, so that as the total number of the wirings increases, the transmissivity in the whole liquid crystal panel decreases and an increase of transmissivity obtained by the white sub-pixel is reduced. Moreover, at least, the doubling of the total number of the wirings extending from the gate driver causes an increase of a total number of drive devices provided in the gate driver and thus causes a cost rise.

The present invention is to solve the problem described above, and an object of the present invention is to provide a liquid crystal display apparatus provided with a liquid crystal panel which makes up one pixel by mixing colors of four sub-pixels in two rows and two columns so that a total number of wirings which transmit drive signals to the sub-pixels can be significantly reduced and transmissivity of the liquid crystal panel can be increased, and a manufacturing cost can be easily reduced by reducing a total number of necessary driver devices which are associated with the wirings.

According to the present invention, this object is achieved by a liquid crystal display apparatus which comprises a liquid crystal panel in which plural sub-pixels of red, green, blue, and a fourth color, which has a higher brightness than the other three colors, are arranged in a column direction and a row direction, and a color of each pixel is made up by mixing the four colors of four sub-pixels which are adjacent to one another in two consecutive columns and two consecutive rows, and a signal control unit which generates drive signals for the respective sub-pixels so as to display an image on the liquid crystal panel in accordance with input image signals.

The signal control unit generates the drive signals for the respective sub-pixels not only so that each pixel of the liquid crystal panel is made up of four sub-pixels which are adjacent to one another in two consecutive columns and two consecutive rows, but also so that there is one column or one row overlap between every four pixels which are adjacent to one another in two consecutive columns and two consecutive rows.

According to the above configuration, the total number of the wirings used to transmit the drive signals can be reduced, because the total number of the sub-pixels required for displaying the pixels can be reduced. Moreover, because the total number of the wirings, which cause the reduction of the transmissivity, is reduced, the transmissivity of the liquid crystal panel can easily be increased. Furthermore, because the number of the driver devices can be reduced in accordance with a reduction of the total number of the wirings, a manufacturing cost can be easily reduced.

Preferably, the signal control unit generates the drive signals for the respective sub-pixels so that there is one column and one row overlap between every four pixels which are adjacent to one another in two consecutive columns and two consecutive rows.

A total number of the sub-pixels arranged in the column direction and the row direction of the liquid crystal panel may be equal to a number, which is obtained by adding 1 to a total number of the pixels to be displayed in the column direction and the row direction, respectively.

Preferably, the signal control unit resolves the input image signals into frequency components of red, green, blue and a fourth color for each of the pixels, and generates the drive signals for the four sub-pixels in the two consecutive columns and the two consecutive rows in accordance with an amount of the respective frequency components. Thus, a process for generating the drive signals for the respective sub-pixels based on the image signals can be simplified.

Furthermore, the fourth color in the four sub-pixels may be white. Thus, the transmissivity of the whole liquid crystal panel can be increased.

### BRIEF DESCRIPTION OF THE DRAWINGS

The present invention will be described below with reference to the annexed drawings. It is to be noted that all the drawings are shown for the purpose of illustrating the technical concept of the present invention or embodiments thereof, wherein:

FIG. 1 is a block diagram of a liquid crystal display apparatus according to a preferred embodiment of the present invention;

FIG. 2 is a diagram showing a process of a frequency resolution of an image data for each pixel in the liquid crystal display apparatus in FIG. 1;

FIG. 3 is a diagram showing a relationship between an arrangement of sub-pixels and reproduced pixels in a liquid crystal panel in the liquid crystal display apparatus in FIG. 1;

FIG. 4 is a diagram showing wirings of a liquid crystal panel to which a line inversion drive is applied in the liquid crystal display apparatus in FIG. 1;

FIG. 5 is a diagram showing wirings of a liquid crystal panel to which a frame inversion drive is applied in the liquid crystal display apparatus in FIG. 1;

FIG. 6 is a diagram showing a relationship between an arrangement of sub-pixels and pixels in a liquid crystal panel in a conventional liquid crystal display apparatus; and

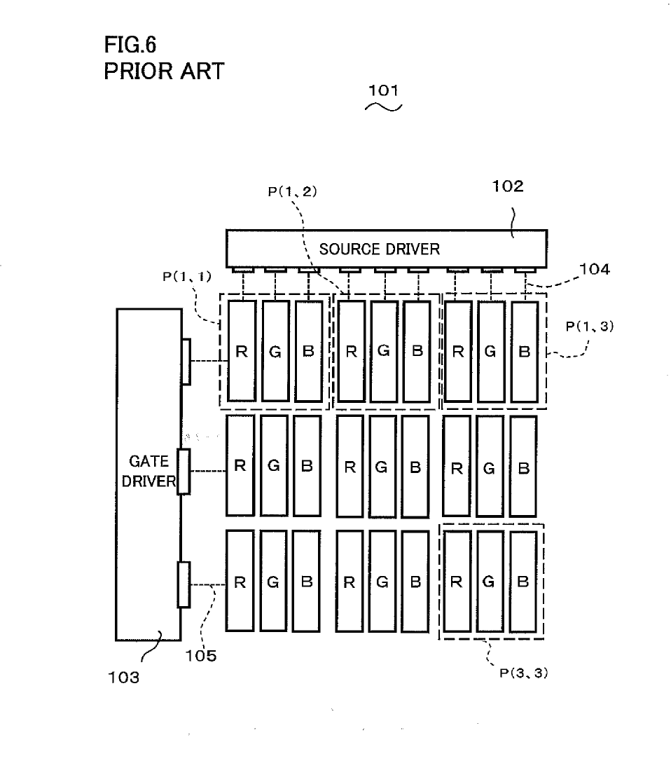

FIG. 7 is a diagram showing a relationship between an arrangement of sub-pixels and pixels in a liquid crystal panel in a conventional liquid crystal display apparatus.

### DETAILED DESCRIPTION OF THE INVENTION

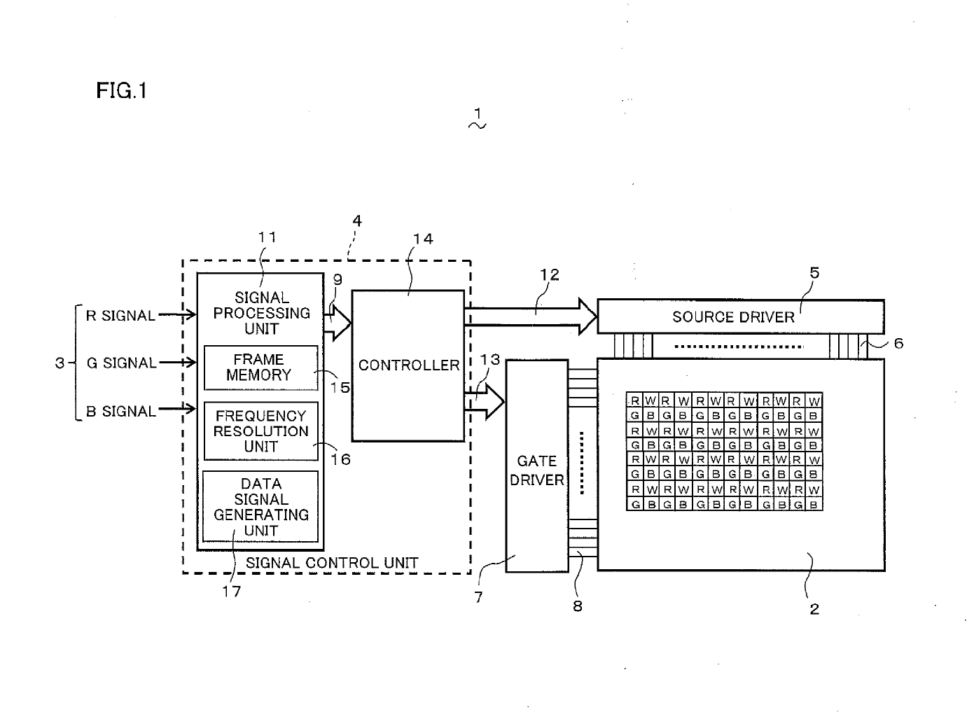

A liquid crystal display apparatus according to a preferred embodiment of the present invention is described with reference to FIGS. 1 to 5. A liquid crystal display apparatus 1 of the present preferred embodiment, which is made up as a display of a television receiver, comprises, as shown in FIG. 1, a liquid crystal panel 2 in which a number of red (R), green (G), blue (B), and white (W) sub-pixels are arranged in rows and columns, and a signal control unit 4 which generates and outputs drive signals to the sub-pixels so that an image according to input image signals 3 is displayed on the liquid crystal panel 2. The input image signals 3 are made up of R signals, G signals, and B signals inputted from a signal source such as a tuner, for example.

The sub-pixels of the liquid crystal panel 2 reproduce a color of one pixel by mixing four emitting colors of red (R), green (G), blue (B), and white (W) sub-pixels, which are adjacent to each other in two consecutive rows and two consecutive columns. Each sub-pixel is connected to a wiring 6 which extends from a source driver 5 in a row direction and a wiring 8 which extends from a gate driver 7 in a column direction. Drive signals (data signals) transmitted from the source driver 5 are applied to the sub-pixels arranged along the column direction in one row at a time in accordance with drive signals (timing signals) transmitted from the gate driver 7, and each sub-pixel emits light at a predetermined brightness level in accordance with the data signals. The light emission of the sub-pixels comes from a forward output of light from a backlight (not shown) by making a liquid crystal layer of each sub-pixel have a predetermined transmissivity in accordance with the data signals.

The signal control unit 4 comprises a signal processing unit 11, which generates drive signals (data signals) 9 to be outputted to each sub-pixel in accordance with the input image signals 3 so that an image which corresponds to the input image signals 3 is displayed on the liquid crystal panel 2, and a controller 14, which adds timing signals to the drive signals (data signals) 9 to generate data control signals 12 and control signals 13 outputted to the source driver 5 and the gate driver 7.

The data control signals 12, which include the drive signals (data signals) 9, are inputted to the source driver 5 and subsequently, converted into the signals of a predetermined format by driver devices such as shift registers, line memories, D/A converters, or the like in the source driver 5 and outputted to the wiring 6. The gate driver 7 has driver devices which convert the control signals 13 into the predetermined format so that they are outputted via the wiring 8.

The signal processing unit 11, which is made up of a microcomputer, comprises a frame memory 15 which temporarily stores the input image signals 3 for each frame, a frequency resolution unit 16 which processes the image data stored in the frame memory 15 into brightness data for each frequency which is weighted in accordance with an amount of each frequency component for each pixel, and a data signal generating unit 17 which generates the drive signals (data signals) 9 applied to each sub-pixel of the liquid crystal panel 2 in accordance with the brightness data for each frequency.

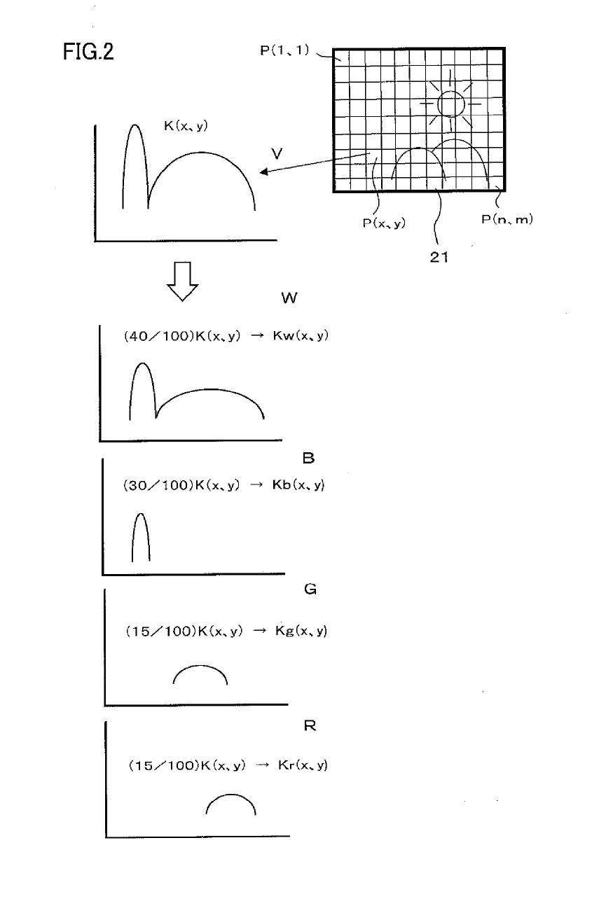

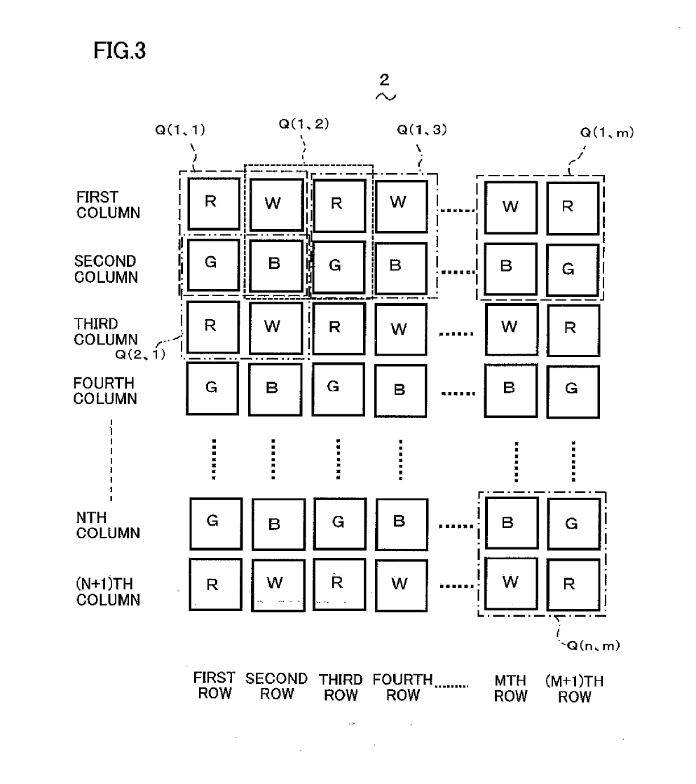

A processing of generating the drive signals (data signals) 9 executed by the signal processing unit 11 is described with reference to FIGS. 2 and 3 hereinafter. For example, when a current image data 21 of one frame stored in the frame memory 15 is shown in FIG. 2, the frequency resolution unit 16 reads out the image data 21 for each pixel, resolves a color (V) of each pixel P (x, y) into the frequency components of white (W), blue (B), green (G), and red (R), weights the brightness of the pixel P (x, y) in accordance with the amount of each frequency component, and generates the brightness data for each frequency.

In particular, when the brightness of the pixels P (1, 1) . . . P (x, y) . . . P (n, m) which make up the image data 21 is K (1, 1) . . . K (x, y) . . . K (n, m), the color (V) of the pixel P (x, y) is resolved as shown in FIG. 2. When a ratio for each frequency corresponding to each color of white, blue, green, and red (white:blue:green:red) is 40:30:15:15, for example, the brightness data for each frequency is (40/100) K(x, y), (30/100) K(x, y), (15/100) K(x, y), and (15/100) K(x, y), respectively. The brightness data for each frequency of white, blue, green, and red generated in this manner are designated as Kw (x, y), Kb (x, y), Kg (x, y), and Kr (x, y), respectively. For example, Kw (1, 1) is a white brightness data which is generated relating to the pixel P (1, 1). The frequency resolution unit 16 repeats the above processing and generates the brightness data for each frequency for all pixels P (1, 1) . . . P (x, y) . . . P (n, m) of the image data 21.

Next, a processing of generating the drive signals 9 of the sub-pixel executed by the data signal generating unit 17 in accordance with the brightness data for each frequency, which is generated in the manner described above, is described with reference to FIG. 3. For convenience of the description, the data signal generating unit 17 executes the processing in order of row and column of the pixel P (x, y), that is to say, in order of P (1, 1), P (1, 2) . . . P (1, m), P (2, 1), P (2, 2), . . . P (n, m), however, the processing does not need to be executed in order of arrangement of the pixel. Each pixel Q (x, y) shown in FIG. 3 corresponds to each pixel P (x, y) shown in FIG. 2.

Firstly, the data signal generating unit 17 applies the brightness data Kw (1, 1), Kb (1, 1), Kg (1, 1), and Kr (1, 1) for each frequency relating to the pixel P (1, 1), to a pixel Q (1, 1) which are made up of a sub-pixel (R) in a first column and a first row, a sub-pixel (W) in the first column and a second row, a sub-pixel (G) in a second column and the first row, and a sub-pixel (B) in the second column and the second row of the liquid crystal panel 2. In particular, the data signal generating unit 17 generates drive data, which corresponds to the red brightness data Kr (1, 1), for the red sub-pixel (R) in the first column and the first row, generates drive data, which corresponds to the white brightness data Kw (1, 1), for the white sub-pixel (W) in the first column and the second row, generates drive data, which corresponds to the green brightness data Kg (1, 1), for the green sub-pixel (G) in the second column and the first row, and generates drive data, which corresponds to the blue brightness data Kb (1, 1), for the blue sub-pixel (B) in the second column and the second row.

Here, the drive data of red, white, green, and blue, which are generated relating to the pixel Q (1, 1), are designated as Dr (1, 1), Dw (1, 1), Dg (1, 1), and Db (1, 1) in this order, respectively. The data signal generating unit 17 stores the drive data Dr (1, 1), Dw (1, 1), Dg (1, 1), and Db (1, 1). When the weighting of the brightness data for each frequency Kr (1, 1), Kw (1, 1), Kg (1, 1), and Kb (1, 1) is 15/100:40/100:15/100:30/100 as described above, the values of the drive data Dr (1, 1), Dw (1, 1), Dg (1, 1), and Db (1, 1) also have a weighting of 15/100:40/100:15/100:30/100 (voltage data). Each of the drive data Dr (1, 1), Dw (1, 1), Dg (1, 1), and Db (1, 1) is a kind of voltage data.

Next, the data signal generating unit 17 applies the brightness data Kw (1, 2), Kb (1, 2), Kg (1, 2), and Kr (1, 2) for each frequency, which relates to the pixel P (1, 2) of the image data 21, to a pixel Q (1, 2) which is adjacently located on a right side of the pixel Q (1, 1) with one row overlap to each other.

In particular, the data signal generating unit 17 applies the brightness data Kw (1, 2) for the sub-pixel (W) in the first column and the second row so as to generate drive data corresponding to the brightness data Kw (1, 2), applies the brightness data Kr (1, 2) for the sub-pixel (R) in the first column and a third row so as to generate drive data corresponding to the brightness data Kr (1, 2), applies the brightness data Kb (1, 2) for the sub-pixel (B) in the second column and the second row so as to generate drive data corresponding to the brightness data Kb (1, 2), and applies the brightness data Kg (1, 2) for the sub-pixel (G) in the second column and the third row so as to generate drive data corresponding to the brightness data Kg (1, 2). Subsequently, the data signal generating unit 17 stores the generated drive data Dw (1, 2), Dr (1, 2), Db (1, 2), and Dg (1, 2).

The data signal generating unit 17 repeats the similar process and generates the drive data for each pixel to the pixel (1, m) in an end of the first column of the image data 21.

Next, the data signal generating unit 17 applies the brightness data for each frequency, which relates to the pixels P (2, 1), P (2, 2), . . . P (2, m) in the second column of the image data 21, to pixels Q (2, 1), Q (2, 2), . . . Q (2, m) which are adjacent to each other with one row overlap to each other in the same manner and sequentially generates the drive data. Here, as shown in FIG. 3, the pixels Q (2, 1), Q (2, 2), . . . Q (n, m) in the second and subsequent columns are arranged with one column overlap to the upper pixel (the nearest upper pixel). For example, the pixel Q (2, 1) is made up of four pixels, that is, the sub-pixel (G) in the second column and the first row, the sub-pixel (B) in the second column and the second row, the sub-pixel (R) in a third column and the first row, and the sub-pixel (W) in the third column and the second row.

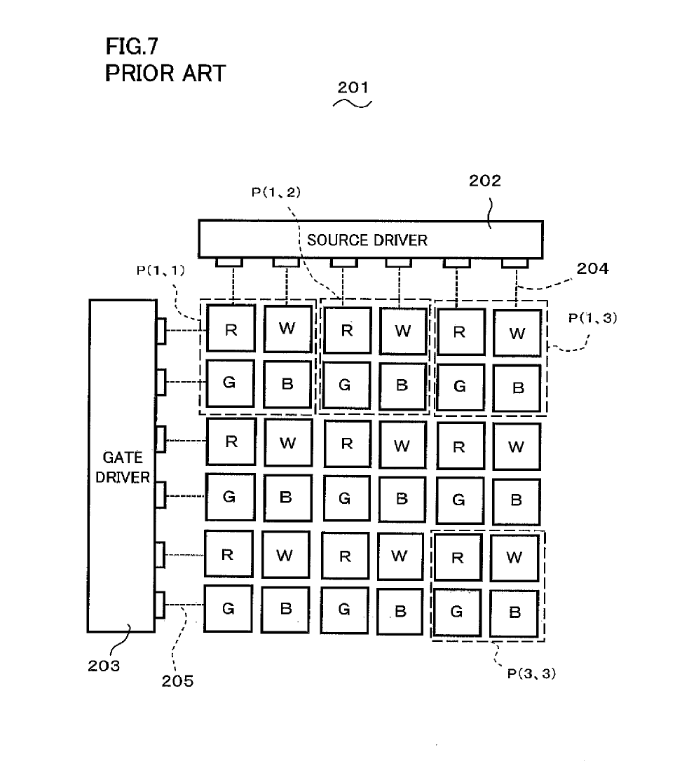

As describe above, the pixel Q (x, y) in the liquid crystal panel 2 which makes up each pixel P (x, y) of the image data 21 is set with one column and one row overlap with the adjacent pixel Q. Accordingly, when total numbers of columns and rows in the pixels of the image data 21 are n and m, respectively, the numbers of the columns and rows of the sub-pixels which make up the liquid crystal panel 2 are (n+1) and (m+1), respectively, which are obtained by adding 1 to the above n and m, respectively. Thus, total numbers of the wirings 6 and 8 are significantly reduced compared to the conventional liquid crystal display apparatus shown in FIG. 7.

As described above, the data signal generating unit 17 adds for each sub-pixel the drive data Dr (1, 1), Dw (1, 1), Dg (1, 1), Db (1, 1) . . . Dr (n, m), Dw (n, m), Dg (n, m), Db (n, m), which relate to the four sub-pixels for each pixel Q (x, y), and determines the added data as the final drive signals (data signals) 9 to be transmitted to each sub-pixel.

For example, only the pixel Q (1, 1) includes the sub-pixel (R) in the first column and the first row as its component, so that the data signal generating unit 17 determines the drive data Dr (1, 1) which is generated relating to the pixel Q (1, 1) as the drive signals (data signals) 9 of the sub-pixel (R) in the first column and the first row directly.

In contrast, the pixels Q (1, 1) and Q (1, 2) include the white sub-pixel (W) in the first column and the second row in common as their components, so that the data signal generating unit 17 adds the drive data Dw (1, 1) and the drive data Dw (1, 2), which are generated relating to the two pixels, respectively, and determines the added data as the drive signals (data signals) 9 of the sub-pixel (W) in the first column and the second row. In particular, the drive signals (data signals) of the sub-pixel in the first column and the second row are designated as (Dw (1, 1)+Dw (1, 2)). The data signal generating unit 17 repeats the similar process and determines the drive signals (data signals) 9 for each sub-pixel in the first column.

The sub-pixels in the second and the subsequent columns are also arranged with one row overlap to each other except for rightmost and leftmost sub-pixels, so that the data signal generating unit 17 adds the four data which are generated relating to the four pixels and determines the added data as the drive signals (data signals) 9. For example, the pixel Q (1, 1), Q (1, 2), Q (2, 1), and Q (2, 2) include the blue sub-pixel (B) in the second column and the second row in common as their components, so that the data signal generating unit 17 adds the drive data which are generated relating to each pixel and determines the added data as the drive signals (data signals) 9. In particular, the drive signals 9 of the blue sub-pixel (B) in the second column and the second row are designated as (Db (1, 1)+Db (1, 2)+Db (2, 1)+Db (2, 2)).

The signal processing unit 11 sequentially outputs the drive signals 9 of each sub-pixel generated as above to the controller 14. The drive signals 9 outputted by the signal processing unit 11 are applied to each sub-pixel of the liquid crystal panel 2 via the source driver 5 at a predetermined timing, and the original image is reproduced.

Since the sub-pixels which make up the liquid crystal panel 2 include the white color, a transmissivity is increased. Moreover, as described above, since the total number of the sub-pixels themselves can be reduced, the total number of the wirings 6 and 8 can also be significantly reduced, and the reduction of the total number of the wirings 6 and 8 can also increase the transmissivity. Moreover, since the total number of the wirings 6 and 8 can be reduced, a total number of the driver devices such as the D/A converters, for example, mounted on the source driver 5 and the gate driver 7, can be reduced, and a manufacturing cost can thereby be easily reduced.

When the signal processing unit 11 does not process one frame of the image data each time but processes ½ frame each time, for example, the frame memory 15 can be replaced with a memory such as a line memory, for example, which has a smaller capacity than a memory which stores one frame. Moreover, although the transmissivity is reduced, a yellow sub-pixel can also be applied instead of the white sub-pixel (W). When the yellow sub-pixel is applied, the frequency resolution unit 16 resolves a color of each pixel P into the frequency components of yellow, blue, green, and red.

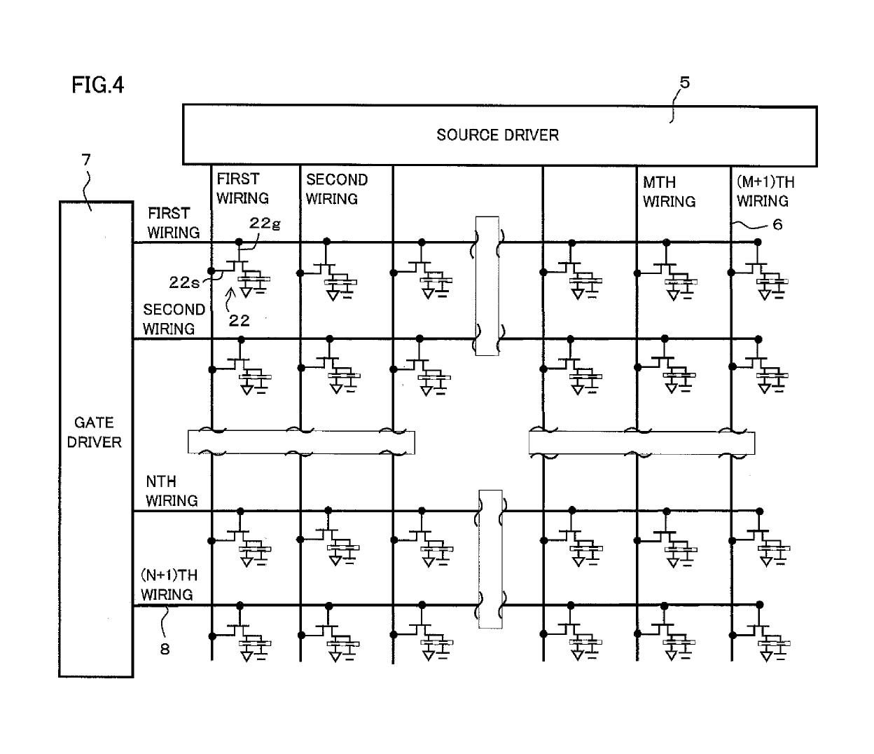

FIG. 4 shows actual wirings of the liquid crystal panel 2. In a TFT 22 which makes up each sub-pixel, a gate terminal 22g is connected to the wiring 8 extending from the gate driver 7, and a source terminal 22s is connected to the wiring 6 extending from the source driver 5. As described above, the total numbers of the sub-pixels in each column and row are (m+1) and (n+1), respectively, so that the total numbers of the wirings in column and row are (n+1) and (m+1), respectively. In contrast, in the liquid crystal display apparatus 201 shown in FIG. 7, (2×n) wirings and (2×m) wirings are required in the column direction and the row direction, respectively.

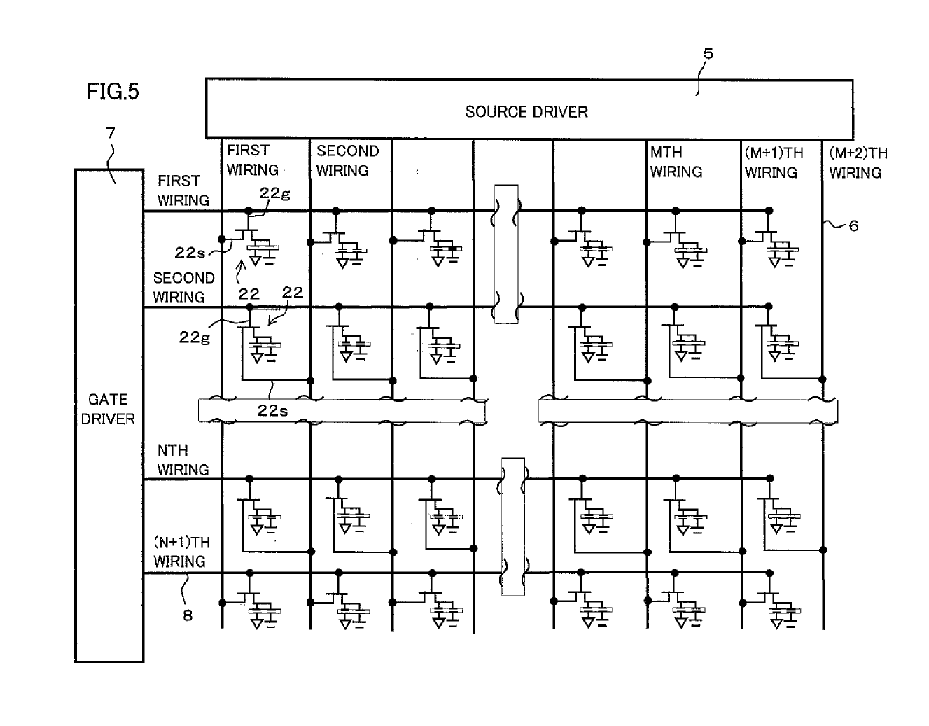

FIG. 4 shows the wirings in the case where a line inversion system is applied as a drive system of the TFT 22. When a frame inversion system is applied as the drive system of the TFT 22, the number of the wirings 6 extending from the source driver 5 is increased by 1, that is (m+2), as shown in FIG. 5. Even in this case, the number of the wirings is significantly reduced.

As described above, according to the liquid crystal display apparatus 1 of the present invention, the signal control unit 4 generates the drive signals for the respective sub-pixels not only so that each pixel of the liquid crystal panel 2 is made up of four sub-pixels which are adjacent to one another in two consecutive columns and two consecutive rows, but also so that there is one column and one row overlap between every four pixels which are adjacent to one another in two consecutive columns and two consecutive rows. Thus, the total number of the sub-pixels required for displaying the pixels can be reduced. Accordingly, the total number of the wirings used to transmit the drive signals can be reduced. Moreover, since the total number of the wirings, which cause the reduction of the transmissivity, is reduced, the transmissivity can easily be increased. Furthermore, the number of the driver devices can also be reduced.

1. A liquid crystal display apparatus comprising:
a liquid crystal panel in which plural sub-pixels of red, green, blue, and a fourth color, which has a higher brightness than the other three colors, are arranged in a column direction and a row direction, and a color of each pixel is made up by mixing the four colors of four sub-pixels which are adjacent to one another in two consecutive columns and two consecutive rows; and
a signal control unit which generates drive signals for the respective sub-pixels so as to display an image on the liquid crystal panel in accordance with input image signals,
wherein the signal control unit generates the drive signals for the respective sub-pixels not only so that each pixel of the liquid crystal panel is made up of four sub-pixels which are adjacent to one another in two consecutive columns and two consecutive rows, but also so that there is one column or one row overlap between every four pixels which are adjacent to one another in two consecutive columns and two consecutive rows.

2. The liquid crystal display apparatus according to claim 1,
wherein the signal control unit generates the drive signals for the respective sub-pixels so that there is one column and one row overlap between every four pixels which are adjacent to one another in two consecutive columns and two consecutive rows.

3. The liquid crystal display apparatus according to claim 2,
wherein a total number of the sub-pixels arranged in the column direction and the row direction of the liquid crystal panel is equal to a number, which is obtained by adding 1 to a total number of the pixels to be displayed in the column direction and the row direction, respectively.

4. The liquid crystal display apparatus according to claim 3,
wherein the signal control unit resolves the input image signals into frequency components of red, green, blue and a fourth color for each of the pixels, and generates the drive signals for the four sub-pixels in the two consecutive columns and the two consecutive rows in accordance with an amount of the respective frequency components.

5. The liquid crystal display apparatus according to claim 4,
wherein the fourth color is white.

6. The liquid crystal display apparatus according to claim 2,
wherein the signal control unit resolves the input image signals into frequency components of red, green, blue and a fourth color for each of the pixels, and generates the drive signals for the four sub-pixels in the two consecutive columns and the two consecutive rows in accordance with an amount of the respective frequency components.

7. The liquid crystal display apparatus according to claim 6,
wherein the fourth color is white.

8. The liquid crystal display apparatus according to claim 1,
wherein the signal control unit resolves the input image signals into frequency components of red, green, blue and a fourth color for each of the pixels, and generates the drive signals for the four sub-pixels in the two consecutive columns and the two consecutive rows in accordance with an amount of the respective frequency components.

9. The liquid crystal display apparatus according to claim 8,
wherein the fourth color is white.

10. The liquid crystal display apparatus according to claim 3,
wherein the fourth color is white.

11. The liquid crystal display apparatus according to claim 2,
wherein the fourth color is white.

12. The liquid crystal display apparatus according to claim 1,
wherein the fourth color is white.
